(19) United States
(12) Patent Application Publication
(10) Pub. No.: US 2008/0196514 A1
(43) Pub. Date: Aug. 21, 2008

(54) Inhalable Sampler

(76) Inventor: James A. Kenny, Portland, CT (US)

Correspondence Address: BLANK ROME LLP, ONE LOGAN SQUARE, PHILADELPHIA, PA, 19103, US

(21) Appl. No.: 12/033,742

(22) Filed: Feb. 19, 2008

Related U.S. Application Data
(60) Provisional application No. 60/902,000, filed on Feb. 16, 2007.

(51) Int. Cl. G01N 1/24

(52) U.S. Cl. 73/863.23

(57) ABSTRACT

A personal dust sampler for collecting airborne inhalable dust. A sampler body provides vertical elutriation by comprising an entry aperture at a distal end exposed to ambient air and having an inner diameter for air intake, and an air exit at a proximal end connected to a pump for drawing air through and along a longitudinal axis of the sampler body to filter media disposed therein for dust capture. A distance along the longitudinal axis between the filter media and the entry aperture defines an air intake length, where the length is greater than the inner diameter of the entry aperture. The air intake length could also be two, three or four or more times greater than the entry aperture inner diameter. The longitudinal axis could be arranged substantially vertically during use, so the entry aperture lies in a horizontal plane, simulating nose orientation and breathing through the nose.

### RELATED APPLICATIONS

This application claims benefit of U.S. Provisional Application Ser. No. 60/902,000, filed Feb. 16, 2007, entitled “Inhalable Sampler,” which is incorporated herein by reference.

### FIELD OF THE INVENTION

The present invention relates generally to dust collection and sampling, and particularly to a personal air sampler suitable for collecting an inhalable particulate mass fraction of airborne dust in workplaces.

### BACKGROUND OF THE INVENTION

An inhalable sampler collects the fraction of airborne material that can enter the nose and mouth during breathing. The ACGIH (American Conference of Industrial Hygienists) provides sampling criteria for inhalable particulate mass. The ACGIH's Threshold Limit Value (TLV) committee is considering replacing many of its single-value aerosol standards with standards for inhalable, thoracic and respirable dust fractions. There are now 21 compounds including wood dust that specify a TLV for inhalable dust fraction. Others include asphalt fume, flour dust, synthetic vitreous fibers (fiberglass), magnesium oxide, caprolactum, nickel, tungsten and molybdenum. Accordingly, accurate measurement of inhalable dust fraction, ever important for worker safety, is now more important than ever for compliance.

Existing inhalable samplers are known to suffer from positive bias due to projectile particles impinging into the open, entry end of the sampler. Also, current inhalable samplers requiring set-up are far more expensive than traditional cassette samplers, costing between $150-$500 per device. Also, cost and time allotted for ordering, special handling and setting up of inhalable samplers are often perceived as an inconvenience by the end user. While some existing devices offer additional accessories (e.g. screens) to attempt to reduce the referenced bias, the accessories only add to sampler cost.

Most current devices require field removal of the filter device, which can lead to field contamination of the filter and/or loss of sample from the filter. Some inhalable devices are designed for horizontal entry of particulate (i.e., mouth orientation). However, nose orientation would more closely resemble average breathing.

What is needed is an inexpensive and disposable personal air sampler that minimizes collection of projectile particles not likely inhaled; one that could, as an alternative to disposal, be cleaned and reused for cost effectiveness. Additionally, a sampler is needed that does not require removal of the filter in the field, to therefore eliminate possible contamination and/or sample loss; one that simulates nose breathing in the workplace; and one that provides vertical elutriation to reduce collection of projectile particles. The present invention addresses these problems.

### SUMMARY OF THE INVENTION

The present invention provides a personal inhalable air sampler used with a pump to collect and measure an inhalable dust fraction, and addresses the high cost and inconvenience of available inhalable samplers. The present invention provides a more accurate sample of actual inhalable mass particulate than currently available samplers, while using the same linear capture velocity and filter media size, if desired.

The invention also offers vertical elutriation, through use of an extended cowl on the sampler, to reduce the positive interfering effect of projectile particles that can bias existing inhalable samplers. The device is preferably disposable, but could also be adapted for cleaning and reuse.

The invention also provides improvements in the methods of collection of dust samples in the field for occupational exposure evaluations by providing nose orientation to better simulate individual breathing in the workplace. The method and devices taught herein therefore improve collection of the inhalable particulate mass fraction of airborne dust.

In one aspect, the personal air sampler for collecting and measuring an inhalable particulate mass fraction of airborne dust includes a sampler body having an entry aperture at a distal end exposed to ambient air and having an inner diameter for air intake. The sampler body also has an air exit at a proximal end adapted to communicate with a pump to draw air through, and along a longitudinal axis of, the sampler body. A filter media is disposed within the sampler body for dust capture. The distance along the longitudinal axis between the filter media and the entry aperture defines an air intake length. The air intake length is greater than the inner diameter of the entry aperture.

In other aspects, the air intake length may be at least twice as great as the inner diameter of the entry aperture. In still others, the air intake length is three or four or more times as great as the inner diameter of the entry aperture. In some embodiments, the inner diameter of the sampler body is equal along the entire air intake length. In other aspects, the inner diameter varies along its length.

Another aspect includes an air sampler having a sampler body with an entry aperture including an inner diameter at a distal end exposed to ambient air for air intake therethrough, and a proximal end adapted to engage a base. The sampler also includes a base having a distal end with inner diameter adapted to engage the sampler body, a proximal end adapted to communicate with a pump means to draw air through the sampler body and the base, and a filter media for dust capture. The filter is disposed within an engagement area of the sampler body and the base. The engaged sampler body and base also define a longitudinal axis therethrough. The distance along the longitudinal axis between the filter media and the entry aperture is the air intake length, and the air intake length is greater than the inner diameter of the entry aperture.

A method of personal air sampling is also provided. First, a personal air sampler is provided for attachment to a pump to draw air through, and along a longitudinal axis of, the personal air sampler. The longitudinal axis of the air sampler is adapted for arrangement substantially vertically on an individual so that an entry aperture at a distal end of the air sampler is below an air exit at a proximal end of the air sampler. The entry aperture would thereby define a plane lying substantially horizontally to simulate nose orientation, whereby air intake through the sampler would simulate personal breathing through the nose.

### BRIEF DESCRIPTION OF THE DRAWINGS

For the purpose of illustrating the invention, there is shown in the drawing(s) a form that is presently preferred; it being understood, however, that this invention is not limited to the precise arrangements and instrumentalities shown.

FIG. 1 is an exploded side view of one embodiment of a personal inhalable sampler according to the present invention; and

FIG. 2 is a perspective view of another embodiment of a personal sampler of the present invention, oriented (hanging) as though worn by an individual during air sampling in the workplace.

### DETAILED DESCRIPTION OF THE INVENTION

The present invention provides an inhalable sampler for assessing total inspirable dust. The personal inhalable sampler can be carried by an individual for analysis of dust exposure; that is, dust that an individual would likely breath in through their nose or mouth. The sampler is preferably constructed of non-conductive material to reduce static charge.

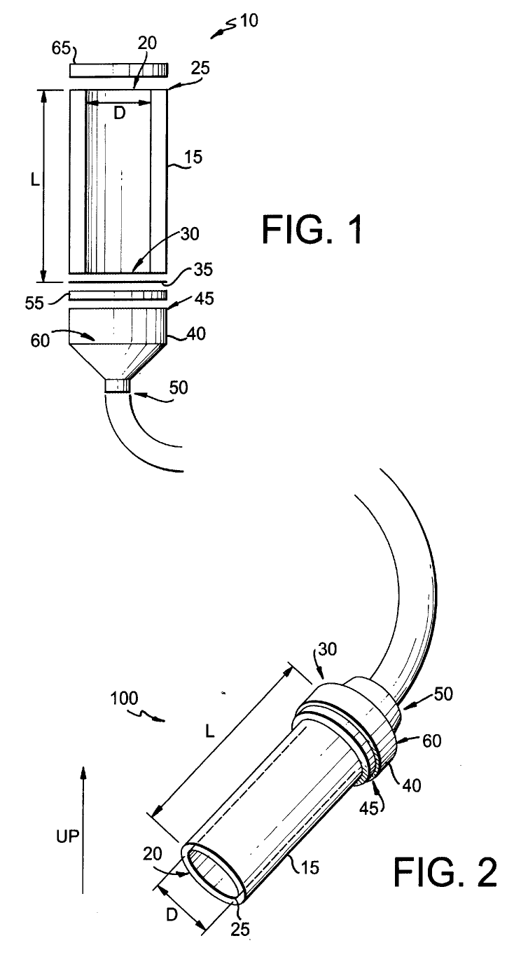

FIG. 1 is an exploded side view of one embodiment of a personal inhalable sampler 10 of the present invention. The sampler 10 has a body 15, or center cowl, with an entry aperture 20 at a distal end 25 that defines an inner diameter “D” of the body 15 for air intake. The body 15 has a proximal end 30 adapted to receive, or communicate with, a filter media 35. The inner diameter D could be equal over a length of the body 15, as in FIG. 1, or could vary over the length, as desired, with a larger diameter being at the proximal end 30 or at the distal end 25. In some embodiments, the inner diameter D might vary directly as a function of the length, so that the body 15 is cone shaped, or shaped as an inverted cone.

In embodiments where the proximal end 30 of the body 15 is adapted to receive the filter media 35, the sampler 10 could be a one piece unit, with the filter media 35 formed integrally within, or later inserted within the body 15. In the FIG. 1 embodiment, however, the sampler 10 also includes a base 40. The base 40 has a distal end 45 adapted to receive the body 15. The base 40 transitions in inner and outer diameter from the distal end 45 to a proximal end 50. The base 40 transition provides a hose connection at the proximal end 50 for connection to a pump means.

The base 40 may be attached to the body 15 in any suitable way, by friction fit, adhesive, fusion, bayonet lock, etc. In the FIG. 1 embodiment, the proximal end 30 of the body 15 traps and secures the filter media 35 and a media support pad 55 against an inner shoulder 60, formed at an inner transition point of the base 40. A removable top cap 65 may accompany the sampler 10, ensuring non-contamination of the internal filter media 35 prior to use.

In view of the description above, the sampler 10 provides an air intake length “L,” defined as a distance along a longitudinal axis of the body 15 between the filter media 35 and the entry aperture 20 at the distal end 25 of the body 15. In the FIG. 1 embodiment, the air intake length L is simply the length of the body 15. In an embodiment where the filter media 35 is disposed within the body 15 (e.g., in a one piece sampler 10), the air intake length L would be less than the total length of the body 15. In an embodiment where the filter media 35 is disposed further proximally within the base 40, the air intake length L may be greater than the total length of the body 15. In any event, in all embodiments of the present invention, the air intake length L is greater than the inner diameter D of the entry aperture 20. However, in some embodiments the air intake length L could be two, three or four or more times greater than the inner diameter D of the entry aperture 20. Flow rate through the sampler 10 is variable, based upon desired sampling conditions, without specific correlation to dimensions of air intake length L and the inner diameter D.

In certain embodiments, the inner diameter D is between 14 mm and 16 mm, with a flow rate likely set between 1.7 liters per minute and 2.3 liters per minute. The air intake length L is at least 17 mm, and could be as much as 85 mm, or more. In other embodiments, the inner diameter D is between 16 mm and 18 mm, with a flow rate likely set between 2.3 liters per minute and 3.0 liters per minute. The air intake length L in the other embodiments is at least 19 mm, and could be as much as 95 mm, or more.

In the FIG. 1 embodiment, the inner diameter D is 15 mm, the air intake length L is 45 mm, and the flow rate would be set at 2 liters per minute. The air intake length L is 3 times as great as the inner diameter D.

FIG. 2 is a perspective view of another embodiment of a personal sampler 100 of the present invention. The FIG. 2 embodiment differs slightly from that illustrated in FIG. 1, due primarily to an outer diameter of the body 15 at the proximal end 30 being greater than the outer diameter of the body 15 at the distal end 25. Otherwise, the personal sampler 100 of FIG. 2 is essentially similar to the personal sampler 10 of FIG. 1; particularly since the value of the inner diameter D of the entry aperture 20 is the same as the value of the inner diameter of the body 15 over the entire length of the body 15. That is, the inner diameter of the body 15 at the proximal end 30 does not follow the taper shown in FIG. 2 for the outer diameter of the body 15. Accordingly, the value of the inner diameter D defines the air intake diameter of the body 15 over the entire air intake length L.

In alternative FIG. 2 style embodiments, the inner diameter of the body 15 at the proximal end 30 follows the taper shown in FIG. 2 for the outer diameter of the body 15. In these alternative embodiments, the inner diameter of the body 15 at the proximal end 30 is greater than the inner diameter D of the entry aperture 20. Therefore, in these alternative embodiments, the value of the inner diameter of the body 15 is the same over nearly the entire length of the body 15. In either case, the air intake length L is greater than the inner diameter D of the entry aperture 20.

In one preferred FIG. 2 embodiment, the inside diameter D is 15 mm. The 15 mm inner diameter D of the entry aperture 20 is retained over the entire length of the body 15. Nearing the proximal end 30 of the body 15, the outer diameter transitions to 25 mm for insertion into the base 40 (as shown). A 25 mm inner diameter base 40 provides, in the present invention, for use of standard 25 mm sampler filter media 35. Only an inner 15 mm diameter portion of the filter media 35, however, is exposed within the body 15 for sample collection.

In this preferred FIG. 2 embodiment, the air intake length L is 63.5 mm. Accordingly, the air intake length L is 4.23 times greater than the inner diameter D. In another preferred FIG. 2 embodiment, the air intake length L is 50.8 mm, resulting in a ratio of air intake length L to inner diameter D of 3.39. Pump operation provides air flow at 2 liters per minute. The extended cowl of the present invention provides vertical elutriation to minimize projectile particles.

The personal sampler 100 of FIG. 2 is shown hanging substantially vertically, as it might when worn by an individual during air sampling in the workplace. In one aspect of use for inhalable air sampling, the personal sampler 100 would be attached by hose to a pump means (not shown) to draw air through, and along the longitudinal axis of, the personal air sampler 100. Due to substantially vertical orientation (as shown), the entry aperture 20 is below an air exit at a proximal end 50 of the air sampler 100. The entry aperture 20 therefore defines a substantially horizontal plane to simulate nose orientation of the individual. Accordingly, air intake through the sampler 100 simulates personal breathing through the nose. Nose orientation (vertical orientation) of the personal sampler 100 further provides (in addition to the extended cowl) for vertical elutriation to reduce the positive interfering affects of projectile particles that often bias current inhalable samplers.

For use, the filter media 35 of the personal sampler 10, 100, can be pre-weighed prior to sampler 10, 100, assembly. Pre-weighing can occur in a manufacturing facility or in a laboratory prior to assembly and use, with weighing of the filter media 35 occurring under laboratory conditions. The sampler 10, 100, is then assembled, sealed and stored until needed, with filter weight noted on packaging. Assembly could also occur in the field. In other sampling situations, the filter media 35 need not be pre-weighed, as the sample collected will be returned to a laboratory for chemical specific, or other type of, analysis.

In use, the sampler 10, 100, is connected to a hose and pump, then draped over the shoulder of, or otherwise carried by, an individual in and around the workplace. At the end of the shift, or other predetermined sampling period, the sampler 10, 100, is disconnected from the hose, and the entire sampler 10, 100, is sealed, stored and later shipped for laboratory weighing and/or other analysis. Due to the inexpensive and disposable nature of the sampler 10, 100, of the present invention, field removal of the filter media 35 is not required, thereby precluding field contamination of the filter media 35, or loss of sample collected on the filter media 35.

The difference between the before and after filter media 35 weight represents dust collected, and is considered total inspirable dust in the respective workplace over the sampling period. The sampler 10, 100, can then be simply thrown away. The weighed filter can then be stored, or additional chemical specific analysis can be performed. The present invention provides quick and easy filter media assembly and disassembly, both before and after sample capture. Being disposable, no cleaning for reuse is necessary, unless desired.

The inhalable sampler of the present invention was tested side-by-side with a typical IOM sampler in a woodworking shop. Twenty four side-by-side samples were taken along with eight duplicate samples (each device sampled in duplicate). Dust concentrations ranged from 0.1-3.0 mg/m³ in the woodworking shop. Analyses revealed that results were not statistically different (p<0.05), although the sampler of the present invention provided results approximately 10-15 percent lower than the IOM sampler. Regression analyses of the sampling devices indicated excellent correlation (R²=0.90). Analyses of paired results indicate that the sampler of the present invention had approximately one-half the variability of the IOM sampler.

What is claimed is:

1. A personal air sampler for collecting and measuring an inhalable particulate mass fraction of airborne dust comprising a sampler body having:
an entry aperture at a distal end exposed to ambient air and having an inner diameter for air intake;
an air exit at a proximal end adapted to communicate with a pump means to draw air through, and along a longitudinal axis of, the sampler body; and
a filter media disposed within the sampler body for dust capture, wherein a distance along the longitudinal axis between the filter media and the entry aperture defines an air intake length, and wherein the air intake length is greater than the inner diameter of the entry aperture.

2. The sampler of claim 1, wherein an inner diameter of the sampler body is equal along the entire air intake length.

3. The sampler of claim 1, wherein the air intake length is at least twice as great as the inner diameter of the entry aperture.

4. The sampler of claim 1, wherein the air intake length is at least three times as great as the inner diameter of the entry aperture.

5. The sampler of claim 1, wherein the air intake length is at least four times as great as the inner diameter of the entry aperture.

6. The sampler of claim 1, wherein the filter media has a diameter of 25 mm and the inner diameter of the entry aperture is 15 mm.

7. A personal air sampler for collecting and measuring an inhalable particulate mass fraction of airborne dust comprising:
a sampler body having an entry aperture with inner diameter at a distal end exposed to ambient air for air intake therethrough, and a proximal end adapted to engage a base;
a base having a distal end with inner diameter adapted to engage the sampler body, a proximal end adapted to communicate with a pump means to draw air through the sampler body and the base, and
a filter media for dust capture disposed within an engagement area of the sampler body and the base, the engaged sampler body and base defining a longitudinal axis therethrough, wherein a distance along the longitudinal axis between the filter media and the entry aperture defines an air intake length, and wherein the air intake length is greater than the inner diameter of the entry aperture.

8. The sampler of claim 7, wherein the air intake length is at least twice as great as the inner diameter of the entry aperture.

9. The sampler of claim 7, wherein the air intake length is at least three times as great as the inner diameter of the entry aperture.

10. The sampler of claim 7, wherein the air intake length is at least four times as great as the inner diameter of the entry aperture.

11. A method of personal air sampling for collecting and measuring an inhalable particulate mass fraction of airborne dust in a workplace, comprising the step of providing a personal air sampler for attachment to a pump means to draw air through, and along a longitudinal axis of, the personal air sampler, where a longitudinal axis of the air sampler is adapted for arrangement substantially vertically on an individual, where an entry aperture at a distal end of the air sampler is below an air exit at a proximal end of the air sampler, and where the entry aperture defines a plane lying substantially horizontally to simulate nose orientation, whereby air intake through the sampler would simulate personal breathing through the nose.

12. A method of personal air sampling for collecting and measuring an inhalable particulate mass fraction of airborne dust in a workplace, comprising the steps of:
attaching a personal air sampler to a pump means to draw air through, and along a longitudinal axis of, the personal air sampler; and
arranging the longitudinal axis of the air sampler substantially vertically so that an entry aperture at a distal end of the air sampler is below an air exit at a proximal end of the air sampler communicating with the pump means, wherein the entry aperture defines a plane lying substantially horizontally to simulate nose orientation, whereby air intake through the sampler simulates personal breathing through the nose.
